(19) United States
(12) Patent Application Publication
(10) Pub. No.: US 2008/0142102 A1
(43) Pub. Date: Jun. 19, 2008

(54) Check Valve and Pump for High Purity Fluid Handling Systems

(76) Inventor: Raymond T. Savard, Pilot Point, TX (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/612,408

(22) Filed: Dec. 18, 2006

(51) Int. Cl. F16K 15/14

(52) U.S. Cl. 137/854

(57) ABSTRACT

A one-way, self-actuating, and springless check valve for high purity fluid handling system and components, including pumps and fluid passageways, includes fixed, but resilient, deformable valve member that cooperates with a valve seat to stop fluid flow in one direction and to bend away from the valve seat when fluid pressure exceeds a predetermined level. The check valve is deployed in a high purity metering pump.

### TECHNICAL FIELD OF THE INVENTION

The present invention relates generally to apparatus used in pumping and metering high purity fluids.

### BACKGROUND OF THE INVENTION

Many of the chemicals used in manufacturing integrated circuits and other devices with very small structures are corrosive, toxic and expensive. One example is photoresist. It is used in photolithographic processes typically employed to fabricate very small structures. In such applications, both the rate and amount of a chemical in liquid phase—also referred to as process fluid or “chemistry”—that is dispensed onto a substrate must be very accurately controlled to ensure uniform application of the chemical and to avoid waste and unnecessary consumption. Furthermore, purity of the process is often critical. The smallest of foreign particles contaminating a process fluid cause defects in the very small structures formed during such processes. The process fluid must be handled by a dispensing system in a manner that avoids contamination. See, for example, Semiconductor Equipment and Material International, “SEMI E49.2-0298 Guide For High Purity Deionized Water And Chemical Distribution Systems In Semiconductor Manufacturing Equipment” (1998). Improper handling can also result in introduction of gas bubbles and damage the chemistry. For these reasons, specialized systems are required for storing and metering fluids in photolithography and other processes used in fabrication of devices with very small structures.

Chemical distribution systems for these types of applications therefore must employ a mechanism for pumping process fluid in a way that permits finely controlled metering of the fluid and avoids contaminating and reacting with the process fluid. Generally, a pump pressurizes process fluid in a line to a dispense point. The fluid is drawn from a source that stores the fluid, such as a bottle or other bulk container. The dispense point can be a small nozzle or other opening. The line from the pump to a dispense point on a manufacturing line is opened and closed with a valve. The valve can be placed at dispense point. Opening the valve allows process fluid to flow at the point of dispense. A programmable controller operates the pumps and valves. All surfaces within the pumping mechanism, lines and valves that touch the process fluid must not react with or contaminate the process fluid. The pumps, bulk containers of process fluid, and associated valving are sometimes stored in a cabinet that also house a controller.

Pumps for these types of systems are typically some form of a positive displacement type of pump, in which the size of a pumping chamber is enlarged to draw in fluid into the chamber, and then reduced to push it out. Types of positive displacement pumps that have been used include hydraulically actuated diaphragm pumps, bellows type pumps, piston actuated, rolling diaphragm pumps, and pressurized reservoir type pumping systems.

Unlike pumps used for many other applications, the inlet and outlet of these pumps are typically opened and closed by switching two-way and three-way valves rather than one-way check valves. When the pump draws in fluid into its pumping chamber, an inlet from a fluid source must be opened and an outlet must be closed. In a pump that utilizes a single opening to draw fluid into and to pump fluid out of the pumping chamber, a two-position, three-way valve couples the opening to inlet and outlet lines. In one position, the valve connects the inlet to the opening and in the other position it connects the opening to the outlet. If the pump has separate inlet and outlet openings, two two-way valves are respectively coupled with the openings for the inlet and outlet. Each two-way valve has an open and a closed position. Each includes an element that must be moved. It blocks flow in one position and allows flow in either direction in a second position. An actuator, such as a solenoid or motor, is typically employed to move the position of the element in two-way and three-way valves. An electronic controller synchronizes actuation of the valves with the pumping mechanism.

One advantage of one-way check valves is that they can be made to self-actuate using pressure within the fluid passageway. No independent actuation is required to open and close them. Once fluid pressure across the valve, in a direction of flow, builds to a certain level, referred to as the “cracking pressure,” an element in the valve is displaced by the pressure, allowing the fluid to pass through a fluid passageway. When the pressure differential drops to a certain pressure, called the seating pressure, the valve reseats itself and seals the fluid passageway. Pressure in the opposite direction will seal the valve.

Despite the advantages of simpler design and control, check valves are not typically used in semiconductor and other high purity manufacturing operations, including in pumps. One reason is the potential for particulate contamination arising from biasing springs, particularly wound or coil spring made from metal wire. Many check valve designs, particularly those that are self-actuating, rely on biasing springs to apply a force to the valve to keep it seated. Typically made of metal, the stresses and strain on the springs cause particles to break off. Corrosion caused by chemicals being transported also lead to particulates and inconsistent cracking pressures. The SEMI E49.2-0298 guideline recommends using only springless check valves, apparently for this reason. Examples of springless check valves include valves comprised of a disk or ball that is biased against the seat using the force of gravity or magnets.

Another approach to the problem of avoiding corrosion and particulate contamination is to make the spring and other components of the valve from plastic. U.S. Pat. No. 5,848,605 proposes using a plastic spring, poppet and valve seat for high purity chemical dispensing applications. U.S. Pat. No. 4,964,423 proposes use of an annular guide member formed from a disk of material cut with spiraling slots to form, in essence, a radial spring. However, due to instability in the material and complexity of machining a coiled design from plastic, the spring rate of a plastic spring tends to vary by an unsatisfactory amount for applications requiring carefully controlled spring rates, such as those in high precision metering pumps used in high purity chemical dispensing systems. Furthermore, even with a conventional metal spring, the force required to open the check valve can vary depending on the machining tolerances of the spring, which oftentimes is difficult to duplicate with the desired level of precision and sensitivity.

Therefore, despite advantages of simplicity offered by self-actuating check valves, the conventional approach for high purity chemical dispensing applications is to use two-way and three-way valves which must be actuated by a solenoid or other mechanism.

### SUMMARY OF THE INVENTION

The present invention relates generally to high purity chemical dispensing systems and to improved pumps and self-actuating, springless check valves used in such systems.

The appended drawings illustrate examples of a check valve and a pump for high purity chemical dispensing and distribution systems, which embody one or more features of the invention in its preferred form.

### BRIEF DESCRIPTION OF THE DRAWINGS

FIG. 1 is an exploded perspective view of a check valve;

FIG. 2 is a side view of a valve member used in the check valve of FIG. 1;

FIG. 3 is a side section view of the valve member of FIG. 1;

FIG. 4 is an bottom view of the valve member of FIG. 1;

FIG. 5 is a top view of the valve member of FIG. 1;

FIG. 6 is a top view of a valve seat used in the check valve of FIG. 1;

FIG. 7 is a cross-sectional side view of the valve seat of FIG. 6;

FIG. 8 is a cross-sectional side view of the check valve of FIG. 1;

FIGS. 9A and 9B are side section views of the valve member of FIGS. 2-5 in closed and opened positions respectively;

FIGS. 10 and 11 are perspective views of a pump in which the check valve of FIG. 1 is implemented;

FIG. 12 is an exploded view of the pump of FIGS. 10 and 11;

FIG. 13 is a side cross-sectional view of the pump of FIGS. 10 and 11;

FIG. 14 is an exploded perspective view of the inlet and outlet for the pump of FIGS. 10 and 11; and

FIG. 15 is a side view of a pump in an enclosure with fittings and electronic control central circuitry.

### DETAILED DESCRIPTION OF PREFERRED EMBODIMENTS

A springless check valve possessing one or more features of the invention is comprised of a bendable, resilient member made of a material that does not react with the process fluid. The member cooperates with a seat having at least one aperture through which fluid flows. The member blocks fluid flow until the fluid pressure reaches a predetermined level, at which time the member bends away from the seat, breaking the seal and allowing fluid to flow through the opening, without the member translating or rotating. The member is resilient and thus returns to its original shape when the pressure differential drops to a predetermined seating pressure. In order to load the valve, the member is shaped so that mounting it causes some amount of bending when engaging the valve seat, resulting in a biasing force that urges sealing portions of the member against the valve seat.

One exemplary implementation of the check valve includes a valve member having a generally circular configuration, raised in the center, with the edge of its perimeter pressing against an orifice structure to create a seal with the structure that prevents flow of fluid through one or more apertures formed in the structure. The member preferably has a generally conical, hemispherical, paraboloid, or other concave structure designed so that bending of its terminating edges upward creates sufficient clearance for the passage of fluid between valve seat and member. This shape will be generally referred to as a “domed” shape, without implying that it is a true dome. The member is affixed or anchored at or near its center, using for example a stem or elongated member extending from its center. The resulting member, shaped like an umbrella, is easily injection molded.

The check valve avoids contamination caused by use of springs. The valve can be made with sensitive cracking and seating pressures. The valve lends itself to being made with few components, using injection molding processes, thereby simplifying manufacture and assembly of valves with repeatable cracking and seating pressures. Self-actuation avoids the need for complex controls to actuate the valve when used in pumps.

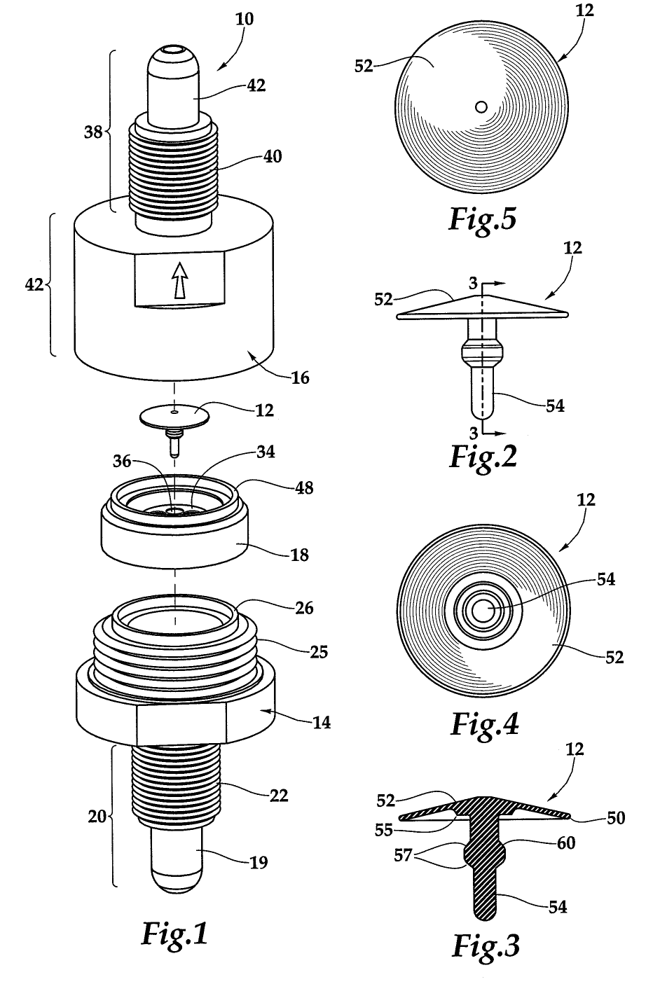

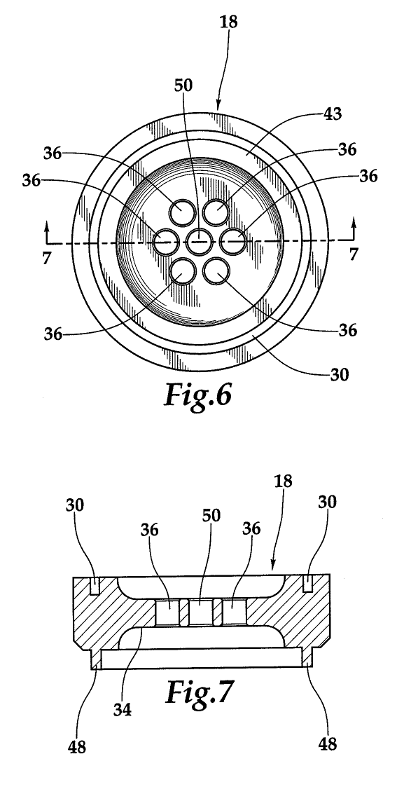

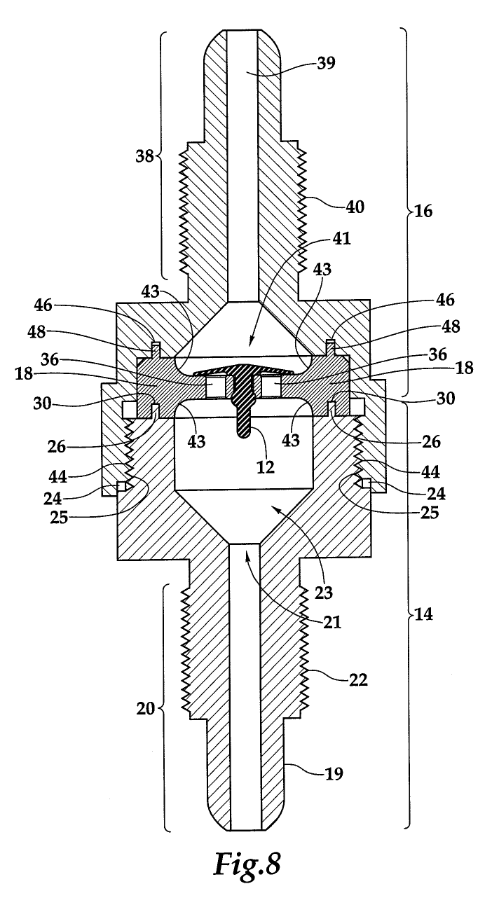

Specific details of this exemplary implementation of the check valve are shown in FIGS. 1-9A and 9B. Check valve 10 comprises a valve body comprised of two halves: inlet housing 14 and an outlet housing 16. The valve housings are preferably made of a material that does not react with process fluids flowing through the valve. In a preferred embodiment they that are made of plastic using an injection molding or similar process.

Valve member 12 cooperates with a seat, through which fluid flows when passing through the valve. In this example, the seat is comprised of orifice plate 18. In the embodiment illustrated, orifice plate 18 comprises a transverse wall 34, through which is defined a plurality of openings 36, which may also be referred to as orifices or apertures for enabling fluid flow between inlet and outlet housings 14 and 16.

Valve member 12 is formed of a flexible, but resilient material such as, for example, an elastomer. In a preferred embodiment useful for semiconductor manufacturing, it is made from a perfluoropolymeric elastomer. It deforms when sufficient force is placed on it, but it returns to its original shape when the force is removed. In its normal, closed position, valve member 12 is in sealing engagement with orifice plate 18 to prevent fluid flow between inlet and outlet housings 14 and 16. Perfluoropolymeric elastomer materials do not react with common semiconductor manufacturing fluids, such as photoresist.

In this example, the inlet and outlet housings 14 and 16 cooperate to trap and retain orifice plate 18 when the two housings are assembled, permitting assembly without the need to use fasteners beyond what is used to connect the inlet and outlet housings. The inlet housing 14 and the outlet housing 16 are joined, for example, using a threaded connection as shown. The inlet housing includes a threaded exterior portion 25 cooperating with a complimentary threaded interior portion 44 of outlet housing 16 to join the two housings together.

The orifice plate is larger in diameter than diameter of the inlet in order to accommodate a supporting structure to which the valve member is attached without restricting the flow to unacceptable levels.

Furthermore, it is preferred to avoid use of a separate seal, such as an O-ring, gasket or other compressible structure, for sealing off flow between the orifice plate and the valve housing. In the illustrated example, a tongue and groove arrangement is used to form a seal between the orifice plate 18 and inlet housing 14, as well as between the orifice plate and outlet housing 16. Annular ridge 26 on inlet housing 14 forms a tongue that cooperates with an annular groove 30 formed in orifice plate 18 when the orifice plate is properly aligned with the inlet housing during assembly. Similarly, annular ridge 48 on orifice plate 18 forms a tongue that cooperates with an annular groove 46 formed in outlet housing 16. In each case, the locations of the tongue and groove may be switched between the components. Additional seals could also be employed if desired.

The assembled valve preferably defines fluid passages that avoid formation of “dead spaces,” in which fluid will tend to collect or pool, and in which small air bubbles could become entrapped and accumulate. In the illustrated example, square corners within the fluid passages are generally avoided. For example, inlet fluid passageway 21 gradually widens at section 23 once it enters the valve housing at entrance 21 to roughly the size of the orifice plate. The inside surfaces of the fluid passageway form in this example a conical shape, which is preferred for maintaining flow, but other shapes avoiding dead spaces and achieving relatively smooth fluid flow could be substituted. This generally conical shape helps to maintain flow of fluid through the housing. Similarly, outlet housing 16 possesses an outlet passageway, generally designated 39, with a tapered section 41. The inside wall of tapered section 41 is, like section 23 of the inlet passageway, conical. Corners of 43 of the orifice plate 18 are formed with a radius to eliminate dead area and provide smooth transitions between the surfaces of the orifice plate and the surface of the passageways at the juncture of the orifice plate and each of the housings.

Optionally, inlet and outlet housings 14 and 16 each have an integrally formed fitting suitable for connection with a hose or line for carrying process fluids, preferably a high purity fitting. In the illustrated example, each housing includes a flare fitting integrally formed with it, so that it can be molded as a single part. The fittings could be formed separately if desired. Doing so loses the advantages of having fewer parts and simpler assembly, but gains the advantage of being able to change the fittings. The flair fitting includes a body 20, comprised of a tip 19, over which the end of a tube fits, and a threaded portion 22, which couples with a nut for clamping the hose to the fitting. Similarly, outlet housing 16 is also integrally formed with a flare fitting with a body 38, comprised of a tip 42 and threaded exterior portion 40. The inlet and outlet housings could also be formed with different types of high-purity fittings. Examples include Super Type Pillar Fitting® and Super 300 Type Pillar Fitting® of Nippon Packing Co., Ltd., Flowell® flare fittings, Flaretek® fittings from Entegris, “Parflare” tube fittings from Parker, LQ, LQ1, LQ2 and LQ3 fittings from SMC Corporation, Furon® Flare Grip® fittings and Furon® Fuse-Bond Pipe from Saint-Gobain Performance Plastics Corporation.

An example of a preferred embodiment of valve member 12 is comprised of a circular, dome shape portion, with a central stem for connecting it with a valve seat. A cap portion 52 is joined with a central stem 54. The stem 54 affixes the cap in a predetermined relationship with orifice plate 18. Stem 54 is configured to be pushed through aperture 50 formed in wall 34 of the orifice plate. It is preferred that the stem 54 is integrally formed with the cap portion 52 in order to reduce the number of parts and ensure that a predetermined geometric relationship between the cap and the orifice plate is maintained without employing complex assembly procedures. The valve member is able to be easily replaced in the field. Shoulders 55 and 60 formed on the stem at predetermined locations cooperate with the edges of the aperture 50 in the orifice plate retaining the stem in a fixed position, resulting in the cap maintaining alignment with the orifice plate 18 at a predetermined distance from it. Additional fasteners are not necessary and, indeed, not desirable since they complicate assembly and potentially create other problems with flow. However, fasteners could be used in place of, or in addition to, one or more of the shoulders, if desired. Shoulder 60 includes chamfer surfaces 57 on opposite sides for facilitating inserting and removing the stem from the mounting aperture 50. The material from which the stem is made is sufficiently elastic to squeeze shoulder 60 enough to be inserted through the aperture 50.

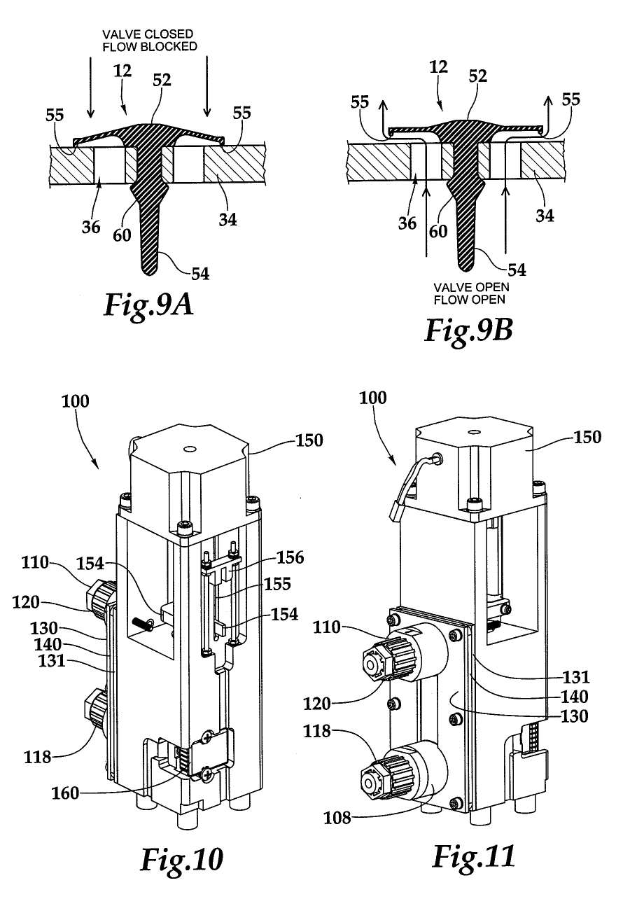

When valve member 12 is installed, cap 52 extends over openings 36, as best illustrated in FIG. 9A, stopping fluid flow until there is sufficient pressure on the underside of the cap 53 to cause it to bend up and away from the orifice plate, as shown in FIG. 9B, to allow fluid to flow. A seal is formed between the outer, circumferential edge 55 of the cap and surface of orifice plate 18 when the valve is in its normal, closed position. To maintain the seal with predetermined cracking pressure, the valve member is biased or loaded by positioning the stem so that, when installed, it pulls the edge 55 firm against the orifice plate, preferably placing the member under strain that generates a loading pressure. A positive pressure differential across the member greater than the cracking pressure bends the valve member. A pressure differential less than a predetermined seating pressure causes the valve member to return to the closed position.

Due to the repeatability of dimensions and material composition when in molding the valve member, cracking pressures of the valve when manufactured in quantities are consistent, thereby preventing fluid flowing backward into the pump.

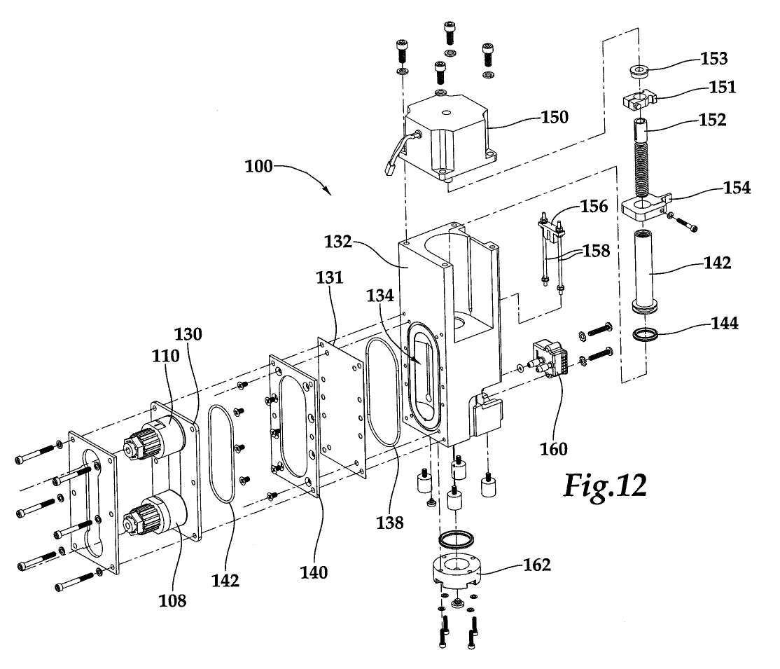

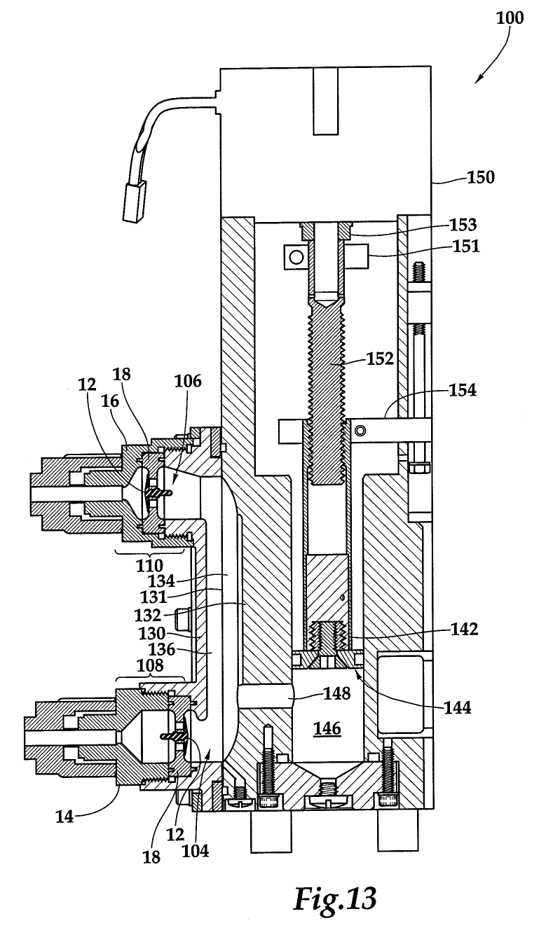

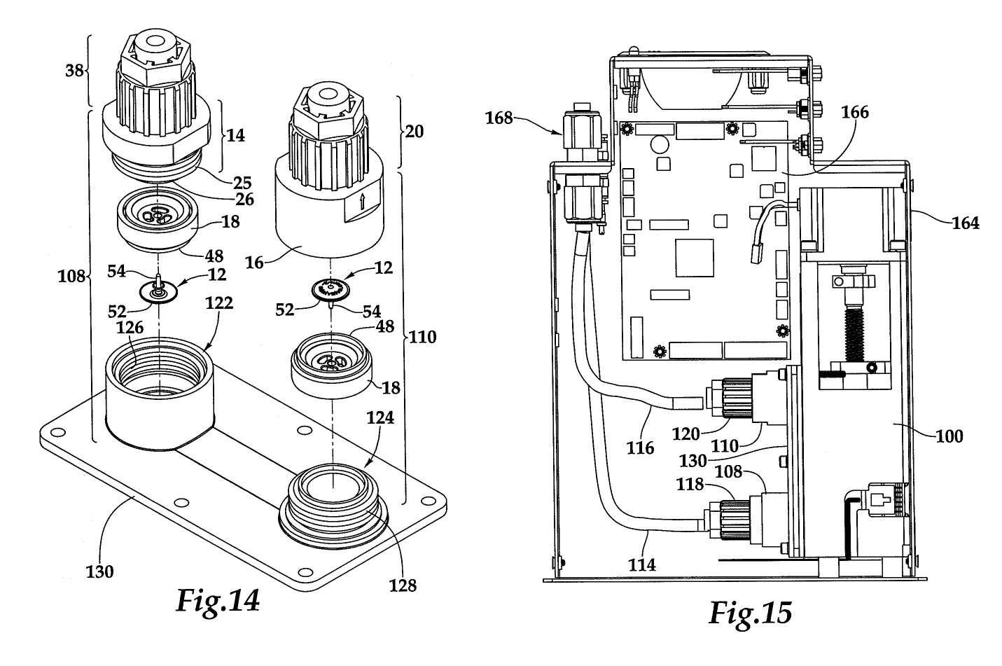

Referring now to FIGS. 10-14, high purity pump 100 is an example of a pump suitable for high purity applications, such as those in semiconductor manufacturing, utilizing self-actuating check valves, such as the one described above, to maintain flow in a single direction through a pumping chamber having a separate inlet and outlet. In this example, the pump is a diaphragm-type, positive displacement pump, which is hydraulically actuated. However, other types of positive displacement pumps could be substituted, such as bellows, rolling diaphragm, and others, and different actuating mechanisms can be substituted.

Pumping chamber 102 includes an inlet 104, generally defined by structure through which fluid enters the pumping chamber, and an outlet 106, which is generally defined by structure through which fluid exits the pumping chamber. The inlet is coupled with a one-way check valve 108, which allows process fluid to flow into the pumping chamber but not out of the pumping chamber. The outlet is coupled with a check valve 110 that allows process fluid to exit the chamber but not enter the chamber.

The check valves are preferably springless check valves comprised of a bendable, resilient valve member made of a material that does not react with the process fluid. The member cooperates with a seat having at least one aperture through which fluid flows. In order to load the valve, the member is shaped so that mounting it causes some amount of strain when engaging the valve seat, resulting in a biasing force that urges sealing portions of the member against the valve seat. The valve member preferably has a generally circular configuration, raised in the center, with the edge of its perimeter pressing against an orifice structure to create a seal with the structure that prevents flow of fluid through one or more apertures formed in the structure. The member preferably has a generally conical, hemispherical, paraboloid, or other concave structure designed so that bending of its terminating edges upward creates sufficient clearance for the passage of fluid between valve seat. The member is preferably affixed or anchored at or near its center, using for example a stem or elongated member extending from its center.

In the illustrated example of FIGS. 10-15, each of the inlet and outlet check valves 108 and 110 are substantially similar to the exemplary check valve illustrated in FIGS. 1-8. Each includes a valve member 12 cooperating with an orifice plate 18, retained between two housings forming at least in part the body of the valve. The primary differences between the inlet and outlet check valves are the orientation of these elements with respect to the pumping chamber. Housing 14 and 16 are substantially the same as those shown in FIGS. 1-8. Each include a fitting 38 and 20, respectively, for coupling to tubes 114 and 116, which respectively carry process fluid to the inlet and carry process fluid from the outlet of the pump. Nuts 118 and 120 are shown attached to fittings. Housings 122 and 124 are similar to housings 16 and 14 respectively, except that they are integrally formed as part of the structures defining the inlet and outlets of the pump and are not joined with fittings for connections with tubing. Each includes a threaded surface 126 and 128, respectively, for coupling with threaded surfaces of housings 14 and 16, respectively.

In the illustrated example, valve housings are integrally formed with pumping chamber top 130. The pumping chamber cover cooperates with diaphragm 131 to form pumping chamber 102. Block 132 defines an actuating fluid cavity 134, and top 130 defines at least in part a process fluid cavity 136. In the exemplary pump, the process fluid and actuation fluid cavities are separated by a flexible, elastic diaphragm 131. The process fluid actuating cavity is also referred to as the pumping chamber. The moving fluid into and out of the actuating fluid cavity 134 causes the diaphragm to move, increasing the volume of the process fluid cavity 136, causing fluid to be drawn in through the inlet, or decreasing the volume and displacing fluid from the cavity, through the outlet. Using an incompressible, hydraulic fluid ensures one-to-one correspondence between a change in the volume of fluid and a change in the volume of the process fluid cavity. O-ring seal 138 seals the actuating fluid cavity between the diaphragm 131 and pump block 132. The diaphragm is held down by plate 140. O-ring seal 142 seals the process fluid cavity between the plate 140 and pumping chamber top 108.

In this example of a hydraulically actuated pump, a piston driven hydraulic pump is used to drive or actuate the pump that pumps the process fluid. Piston 142, mounted with a sliding seal 144, displaces actuating fluid from a hydraulic pump cavity 146 into the actuating fluid cavity 134 through port 148 during its down stroke. During its upstroke, it pulls the actuating fluid from the actuating fluid cavity 134 and into actuating hydraulic pump cavity 146. Displacement of the piston is preferably controlled by a stepper motor 150, which turns a drive screw 152. Clamp 151 attaches the drive screw to the output shaft of the motor. Thrust bearing 153 prevents the drive shaft from axially loading the output shaft of the motor. The threads on the drive screw couple with threads on the inside of the piston 142. The angular position of the piston is fixed by a guide 154, which is clamped to the piston and cooperates with slot 155 to prevent rotation of the piston. Turning the drive screw moves the piston. This type of threaded drive coupling is relatively simple, reliable and accurate. Other couplings could, however, be substituted. An optical sensor 156, adjustably mounted on screws 158, detects when guide 154, and thus piston 142, is at a predetermined limit during upstroke. This is used to calibrate the pump. Pressure sensor 160 senses pressure within the hydraulic pump and actuating fluid cavities 134 and 146. Cover 162 seals an opening that allows access to the hydraulic pump cavity 146 for assembly and cleaning. As compared with other mechanisms used in hydraulically actuated positive displacement pumps, such as tubefram and chain driven bellows systems, this hydraulic actuation system uses a simple, flat diaphragm and its piston arrangement avoids complicated drive mechanisms.

Orienting the pumping chamber vertically as shown in the example, so that the inlet is at the bottom of the pumping chamber and the outlet is out the top, tends to reduce the potential for development of stagnant areas in which process fluids and air bubbles might tend to accumulate. Furthermore, the surfaces of the pumping chamber are arranged to avoid places, in which process fluid might tend to pool and stagnate. They exclude, for example, sharp corners.

As exemplified by FIG. 15, the pump is preferably mounted vertically within an enclosure 164, along with electronic circuitry 166 used to control its operation. External fittings 168 are used to connect to lines leading to dispense points and a process fluid source.

Alterations and modifications to the disclosed embodiments are possible without departing from the invention. It is intended that the scope of the invention disclosed herein be limited only by the broadest interpretation of the appended claims to which the inventors are legally entitled.

What is claimed is:

1. A high purity fluid handling apparatus, comprising:
a body having portions defining a flow path for communicating process fluid from an inlet to an outlet, portions of the body defining the flow path comprised of a material that does not react with or contaminate process fluid used in high purity applications
a valve seat;
a valve member cooperating with the valve seat for stopping flow of process fluid through the valve seat in the direction of the inlet, the valve member bending away from the valve seat for allowing flow of process fluid through the valve seat, in the direction of the outlet, when process fluid pressure exceeds a predetermined level in the direction of the outlet; the valve member comprised of an elastic, resilient material that does not react with or contaminate the process fluid, the valve member being fixed with respect to the valve seat so that it bends to allow flow of process fluids through the valve seat without being displaced.

2. The high purity fluid handling apparatus of claim 1, further comprising a pump having a pumping chamber, an inlet to the pumping chamber and an outlet from the pumping chamber, the outlet of the body coupled with the inlet to the pumping chamber for communicating process fluid to the pumping chamber, but preventing flow of process fluid from the pumping chamber.
